(19) United States
(12) Patent Application Publication
(10) Pub. No.: US 2009/0128352 A1
(43) Pub. Date: May 21, 2009

(54) AUTOMATED HANDS-FREE EVENT INITIATION IN RESPONSE TO POSITION OR OPERATIONAL STATUS OF VEHICLE

(76) Inventor: Kirk B. Urick, Blue Springs, MO (US)

Correspondence Address: SPENCER, FANE, BRITT & BROWNE, 1000 WALNUT STREET, SUITE 1400, KANSAS CITY, MO, 64106-2140, US

(21) Appl. No.: 12/348,893

(22) Filed: Jan. 5, 2009

Related U.S. Application Data
(63) Continuation-in-part of application No. 11/748,693, filed on May 15, 2007, now Pat. No. 7,474,203.
Application No. 11/748,693 is a continuation-in-part of application No. 10/986,266, filed on Nov. 10, 2004, now Pat. No. 7,224,265.
(60) Provisional application No. 60/518,817, filed on Nov. 10, 2003.

(51) Int. Cl. B60Q 1/00

(52) U.S. Cl. 340/686.6

(57) ABSTRACT

The present invention provides a system including a mirror mounted on a vehicle, the mirror being movable between open and closed positions. A motor is provided, the motor being operable to move the mirror to either the open or closed position in response to an actuation signal from an onboard controller. The onboard controller is able to substantially automatically provide the actuation signal to the motor in response to the occurrence of an actuation condition, which is associated with the engaging or disengaging of a transmission of the vehicle.

### CROSS-REFERENCE TO RELATED APPLICATIONS

The present U.S. continuation-in-part application claims priority benefit of an earlier-filed U.S. non-provisional patent application entitled SYSTEM FOR AUTOMATICALLY POSITIONING VEHICLE MIRRORS, Ser. No. 11/748,693, filed May 15, 2007, which, in turn, claims priority benefit of an even earlier-filed U.S. non-provisional patent application entitled AUTOMATIC REMOTE RETRACTABLE MIRRORS, Ser. No. 10/986,266, filed Nov. 10, 2004, which, in turn, claims priority benefit of an even earlier-filed U.S. provisional patent application entitled A.R.R.M. (AUTOMATIC REMOTE RETRACTABLE MIRRORS)™, Ser. No. 60/518,817, filed Nov. 10, 2003. The identified earlier-filed patent applications are hereby incorporated by reference herein.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

It is often desirable to automatically cause the initiation of an event based on the location or operational parameters of a vehicle. For example, it is desirable to fold or unfold (open or close) side mirrors in response to an operational event within a vehicle, or in response to the vehicle's arrival at a predetermined location. Further, activation of various other events is often desired in response to a vehicle's arrival at a predetermined location.

The present invention provides a system for initiating activation of desired events in response to an operational event of a vehicle, or in response to the arrival of the vehicle at a predetermined geographic location. The initiation of an activation event is achieved in a hands-free manner in order to preserve the safety of vehicle operation.

### SUMMARY OF THE INVENTION

The present invention provides a system including a mirror mounted on a vehicle, the mirror being movable between open and closed positions. A motor is provided, the motor being operable to move the mirror to either the open or closed position in response to an actuation signal from an onboard controller. The onboard controller is able to substantially automatically provide the actuation signal to the motor in response to the occurrence of an actuation condition, which is associated with the engaging or disengaging of a transmission of the vehicle.

Another aspect of the present invention provides that the actuation condition is placing the vehicle in park. The motor operates to close the mirror in response to the actuation condition.

In another aspect of the present invention, the actuation condition is placing the vehicle in drive, and the motor operates to open the mirror in response to the actuation signal.

Another aspect of the present invention provides a system that includes a mirror mounted on a vehicle, the mirror being movable between an open position and a closed position. A motor is provided, the motor being operable to move the mirror to either the open or closed position in response to an actuation signal from an onboard controller. The onboard controller substantially automatically provides the actuation signal to the motor in response to the occurrence of an actuation signal, which is associated with the initiation of a shift from a first gear of the vehicle to a second gear of the vehicle.

Still another aspect of the present invention provides a vehicle-mounted system for activation of a remote event. The system includes a transmitter is adapted to transmit an activation signal to a remote receiver for activation of a remote event. The activation signal is transmitted in response to an actuation signal received by the transmitter from an onboard controller. The onboard controller substantially automatically generates the actuation signal when the vehicle enters a predetermined location as determined by global positioning system technology.

In another aspect of the present invention, the remote event is the control of a garage door, and the onboard controller provides the actuation signal to the transmitter when the vehicle enters a predetermined location with respect to the garage door as determined by global positioning system technology.

In still another aspect of the present invention, the remote event is the control of a gate and the onboard controller provides the actuation signal to the transmitter when the vehicle enters a predetermined location with respect to the gate as determined by global positioning system technology.

In another aspect of the present invention, the remote event is the control of a hangar door, and the onboard controller provides the actuation signal to the transmitter when the vehicle enters a predetermined location with respect to the hangar door as determined by global positioning system technology.

In another aspect of the present invention, the remote event is the control of at least one light, and the onboard controller provides the actuation signal to the transmitter when the vehicle enters a predetermined location with respect to the at least one light as determined by global positioning system technology.

In another aspect of the present invention, the remote event is the control of a security system, and the onboard controller provides the actuation signal to the transmitter when the vehicle enters a predetermined location with respect to the security system as determined by global positioning system technology.

### BRIEF DESCRIPTION OF THE DRAWINGS

The present invention is described herein with reference to the following drawings:

FIG. 1 is a depiction of an embodiment of the present system for repositioning a vehicle's mirrors.

FIG. 2 is a block diagram showing various components of the system of FIG. 1.

FIG. 3 is a depiction of a remote transmitter component of the system of FIG. 1.

FIG. 4 is a plan view of the system of FIG. 1 in an operational environment, including the vehicle and a garage.

FIG. 5 is a depiction of a remote transmitter component of the present invention.

FIG. 6 is a schematic representation of one embodiment of the present invention showing exemplary communication pathways amongst exemplary components of the present system.

### DETAILED DESCRIPTION OF THE INVENTION

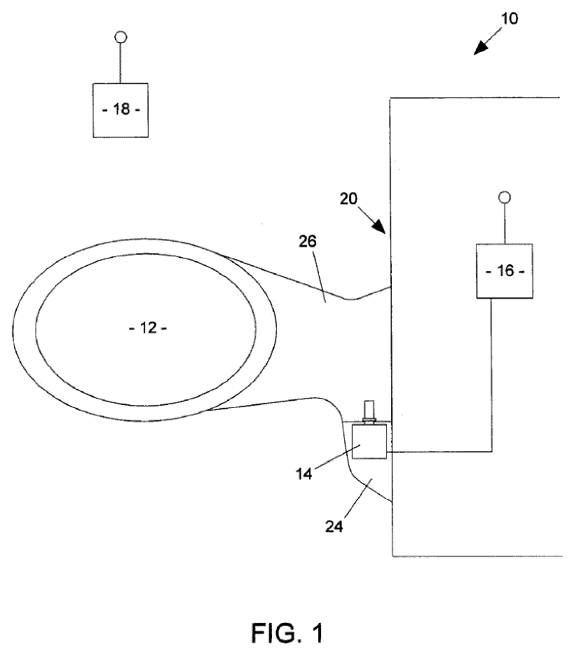

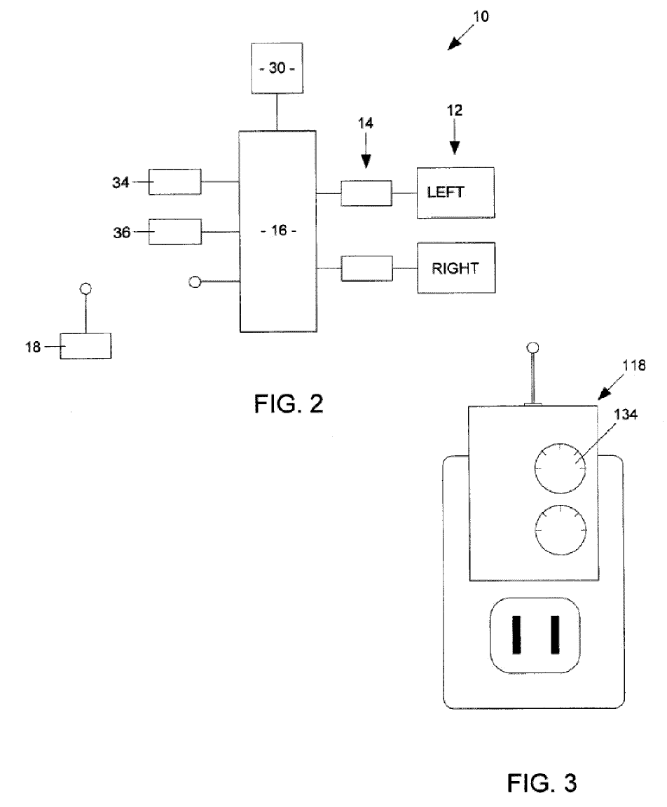

With reference to the figures, the present invention is herein described, shown, and disclosed in accordance with one or more preferred embodiments. Broadly, the present invention concerns a system 10 operable to substantially automatically move a vehicle's mirrors 12 between closed and open positions in response either to a signal received from a remote transmitter 18 or to an action normally taken in the ordinary course of operating the vehicle 20, and thereby avoid damage to the mirrors 12. Referring to FIGS. 1 and 2, one embodiment of the system 10 broadly comprises the mirror 12; a motor 14; an onboard controller 16; and the remote transmitter 18. As shown in FIG. 2, it will be appreciated that, for most vehicles, the system 10 will include two mirrors 12, i.e., left and right, and two corresponding motors 14 which will be substantially identical in structure and operation. Thus, it will be understood that the singular term “mirror”, as used herein, shall refer to either mirror or both mirrors, depending on context, unless otherwise expressly stated.

The mirror 12 may be an otherwise substantially conventional vehicle mirror used by drivers to see what is occurring behind or to the side of them. The mirror 12 may include, as part of its housing, a lower element 24 which is fixedly mounted to the vehicle 20, and an upper element 26 which is pivotably associated with the lower element 24. The mirror 12 may further include a tension spring interposed between the lower and upper elements 24,26 to better control the motion and positioning of the mirror 12.

The motor 14 may be an otherwise conventional electric motor, such as a DC stepper motor. The motor 14 is mechanically connected directly or indirectly, such as by a linkage, to the mirror 12, and operable, in response to an actuation signal, to move the mirror 12 to an alternate position. More specifically, if the mirror 12 is in the open, or “folded out”, position when the actuation signal is received, then the motor 14 moves the mirror to the closed, or “folded in”, position. Similarly, if the mirror 12 is in the closed position when the actuation signal is received then the motor 14 moves the mirror to the open position.

The onboard controller 16 is operable to provide the actuation signal for actuating the motor 14 in response to the occurrence of an actuation condition. The actuation signal provided by the onboard controller 16 may be generated by the onboard controller 16 in response to an actuation condition associated with an action normally taken in the ordinary course of beginning or ending operation of the vehicle 20. Such action may include, for example, inserting or removing the vehicle's key or placing the vehicle's transmission into drive or park. More specifically, an action ordinarily taken in the course of beginning operation of the vehicle 20 would indicate that the mirror 12 should be moved to the open position, while an action ordinarily associated with ending operation of the vehicle 20 would indicate that the mirror 12 should be moved to the closed position. The onboard controller 16 is also operable to provide the actuation signal in response to a signal received from the remote transmitter 18. The onboard controller 16 and the motor 14 receive power from the vehicle's electrical system 30.

As noted above, the actuation signal provided by onboard controller 16 may be generated in response to an actuation condition associated with an action normally taken in the ordinary course of operating the vehicle 20. For example, shifting the gears of the vehicle, such as into Park or Drive, can suffice as an actuation condition leading to movement of mirror 12 to an open or closed position. It is further contemplated that the movement of mirror 12 to an open or closed position may be actuated by the process of shifting gears of the vehicle rather than by a signal generated once a gear shift is complete. Thus, as the operator of vehicle 12 begins to move the vehicle from Park to Drive, an actuation signal may be generated moving mirror 12 from a closed to an open position. Likewise, when the operator of vehicle 12 begins to move the vehicle from Drive to Park, an actuation signal may be generated moving mirror 12 from an open to a closed position.

In one embodiment, the onboard controller 16 is further operable to provide the actuation signal when the vehicle 20 approaches or enters a particular location. The vehicle's location may be determined by onboard global positioning system (GPS) technology, which is incorporated into or accessed by the system 10, or by a remote entity in communication with the system 10. The locations which trigger this feature may include shopping mall parking lots, sports stadium parking lots, airport parking lots, university parking lots, and other locations associated with close clearances and possible damage to the mirror 12.

In one embodiment, the onboard controller 16 is provided by an existing onboard controller. More specifically, certain existing services, such as the well-known ONSTAR® service, allow for remotely controlling certain actions, e.g., unlocking doors, in a vehicle equipped with an onboard controller operable to receive instructions via wireless communication and, in response thereto, accomplish the actions. It is contemplated that such an existing onboard controller may be adapted to also function as the onboard controller 16 of the present invention. Such adaptation is considered to be within the abilities of one with ordinary skill in the art without requiring undue experimentation.

The remote transmitter 18 is operable to provide a signal indicating a special condition, not directly associated with operation of the vehicle, in light of which it is advisable to change the position of the mirror 12. In one embodiment, the remote transmitter 18 is a short range, directional, continuous transmitter. For example, a carwash, drive-through, or garage with relatively close clearance may include the remote transmitter 18 mounted in such a position that its signal is received at the vehicle 20 as it approaches or enters the area of close clearance. The onboard controller 16 receives this signal and provides the actuation signal for actuating the motor 14. In various embodiments, a second remote transmitter may be provided to transmit a signal to the vehicle leaving the area of close clearance to return the mirror 12 to its open position, or the system 10 may be configured so that the mirror 12 returns to its open position as soon as or some measured period after the signal from the remote transmitter 18 is no longer received.

Referring also to FIG. 3, in one embodiment, the remote transmitter 118 takes the form of a unit adapted to plug into a common electrical outlet, such as are found in many residential garages. The remote transmitter 118 may include controls for controlling its operation, including a settable distance control 134 for controlling the distance from the remote transmitter 118 at which the remote transmitter's signal is receivable by the onboard controller 16, e.g., the distance from the garage at which the mirror 12 repositions.

In various embodiments, the system 10 may further include a manually-activated switch 34 for causing the onboard controller 16 to reposition the mirror 12 whenever desired, such as when driving through an area of close clearance which is not provided with the remote transmitter 18 for substantially automatically repositioning the mirror 12. In one embodiment, the switch is a four-position switch, with positions corresponding to the left mirror only, the right mirror only, both mirrors, and “off”. The switch 34 is in communication with the onboard controller 16, such that moving the switch 34 results in a signal being sent to the onboard controller 16, which, in turn, results in the actuation signal being sent to the corresponding mirror 12. In one embodiment, automatic operation of the system 10 will override manual operation, while in another embodiment, manual operation of the system 10 will override automatic operation.

In a similar embodiment, the system 10 may further include a manually-activated key fob transmitter 36 for causing the onboard controller 16 to reposition the mirror 12 from a distance whenever desired, such as when moving away from or toward the vehicle 20. The key fob transmitter 36 may be substantially similar to the switch 34 is operation.

In one embodiment, the system 10 may further include one or more indicators, such as LEDs, for indicating whether the other components of the system 10 are working properly. For example, the indicators may include a green LED which, when lit, indicates proper operation, and a red LED which, when lit, indicates some problem with the system 10. This allows the operator of the vehicle to quickly determine whether he or she can rely on the system 10 to properly position the mirror 12 when needed.

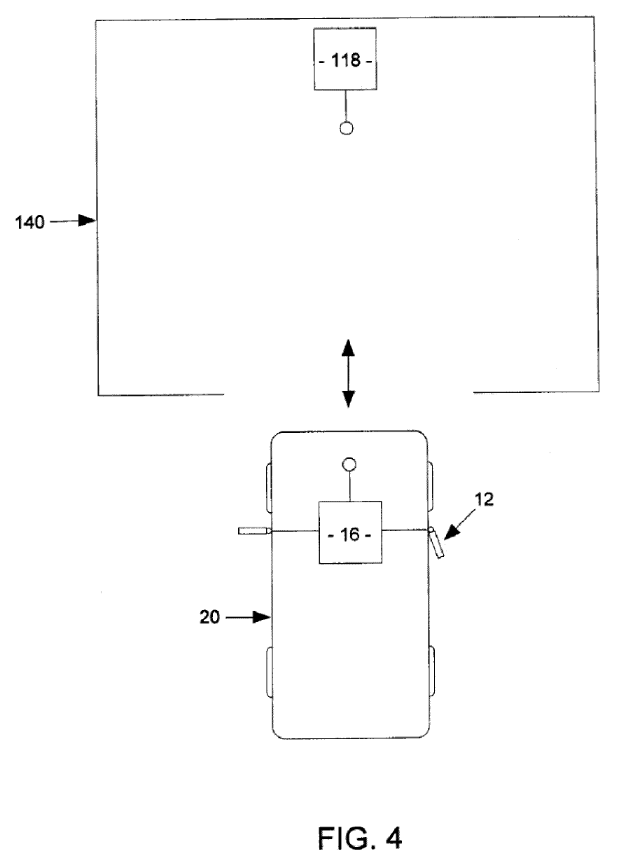

Referring also to FIG. 4, in exemplary use and operation, the system 10 may function substantially as follows. As the vehicle 20, with its mirrors 12 open, approaches a garage 140 in which the remote transmitter 118 is located, the onboard controller 16 receives a signal from the remote transmitter 118 and responds by providing the actuation signal to the motors 14 to substantially automatically move the mirrors 12 to the closed position. If the remote transmitter 118 is not present or not functioning properly, the operator of the vehicle 20 can use the manual switch 34 to cause the mirrors 12 to reposition.

Subsequently, when the vehicle 20, with its mirrors closed, leaves the garage 140 in which the remote transmitter 118 is located, the onboard controller ceases receiving the signal from the remote transmitter 118 and responds by providing the actuation signal to the motors 14 to substantially automatically move the mirrors 12 to the open position. If the remote transmitter 118 is not present or not functioning properly, the operator of the vehicle 20 can use the manual switch 34 to cause the mirrors 12 to reposition.

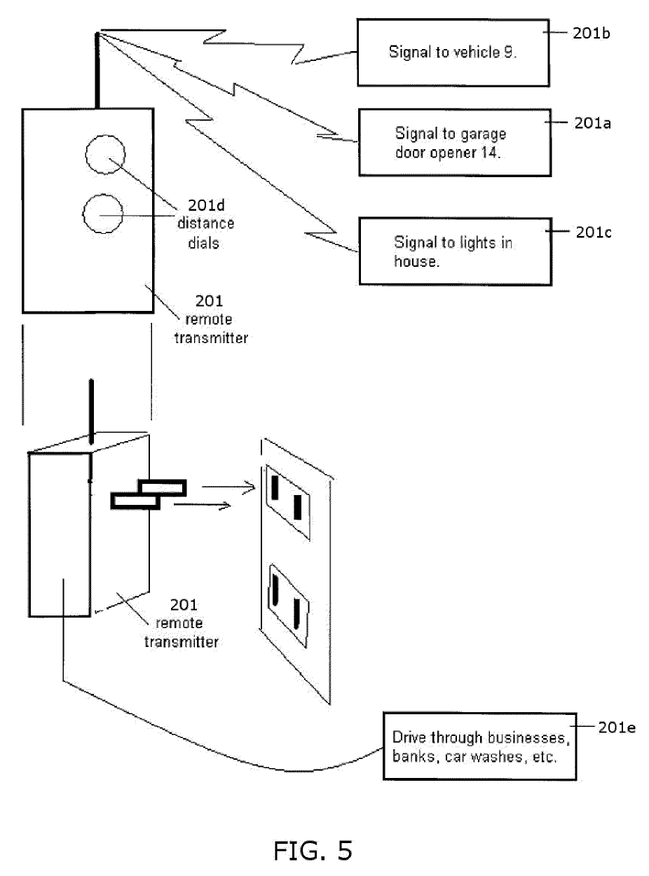

As shown in FIG. 5, aspects of the present invention that determine when a car or other vehicle has approached a certain location are not confined to operating the retractable mirrors 200 of the invention. Rather, any number of ‘activation’ events may take place when a vehicle is sensed to be within proximity of a given location. This includes, but is not limited to, turning on and off lights within a house, office, or other location, activating the opening or closing of a garage door or gate, and activation events related to other businesses such as drive-through businesses, car washes, restaurants, and the like. For example, when the vehicle senses that it is within a given proximity of a car wash, the activation event generated by the present system may include closing any windows or a sunroof of the vehicle. In any of these situations, some embodiments of the present invention provide a remote transmitter 201 with a distance dial 201d included therewith, so an operator of the vehicle can manually set the distance from the target at which the activation event is initiated by the present system.

It is not necessary, however, that the location of a vehicle be determined by sensors within the vehicle and/or at a target location. It is also contemplated that a GPS system within the vehicle may serve to identify the location of the vehicle with respect to certain target locations. For example, a GPS device within a vehicle may be used to determine that the vehicle is approaching the garage of a vehicle owner's home. Having made this determination, the activation event (via, for example, a remote transmitter) may be initiated and the garage door opened. In such embodiments of the present invention there is no need for proximity sensors and the like within the vehicle or at the target location. The position of the vehicle is determined entirely through a GPS system.

It is further contemplated that in preferred embodiments of the present invention, vehicle tracking by a GPS system occurs in real-time, such that the geographic location of the vehicle is known at any given instant in time. Thus, as soon as the vehicle enters the predetermined geographic location, the desired event can be initiated.

The above-described principles of the present invention, relating to actuation events undertaken as a result of GPS data, can be utilized in many applications of the present invention. For example, such a system may be utilized with an airplane such that when the airplane is determined by the GPS system to be within a predetermined proximity to a hanger, an activation signal is generated within the airplane and the hanger is opened to received the airplane. The activation signal may also operate to arm or disarm a security system, such that when a vehicle is within a predetermined proximity to a location and moving away from the location, a security system at the location is armed. When a vehicle is within a predetermined proximity to a location and moving away from the location, a security system at the location is disarmed.

The present system may also interact with a cell phone or SMS messaging system, or other messaging system. In such embodiments, the system may, for example, send a text message or e-mail to a desired recipient when the vehicle reaches a predetermined geographic location. Further, the present system may automatically place a call to a desired recipient when the vehicles enters a predetermined location. It is also contemplated that the vehicle may send a text message, e-mail, or otherwise communicate with a desired recipient at a predetermined time, providing to the recipient the location of the vehicle at that time. Thus, a parent may receive a text message a predetermined time providing the location of a child's vehicle.

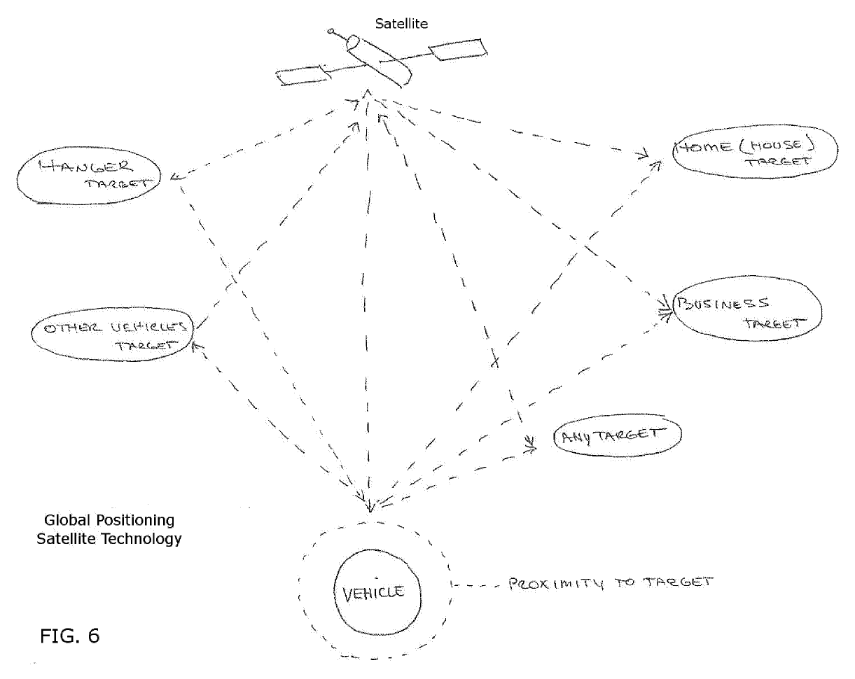

Various pathways of communication between a vehicle, various targets, and a GPS unit are shown in FIG. 6. It is contemplated that in some instances a vehicle may transmit a signal directly to a target, while in other instances the target may receive a signal from the GPS unit. In either case, the desired event may be initiated by the received signal.

It is further contemplated that the word ‘vehicle,’ as used herein, may refer to any automated device for transporting persons, animals, plants, objects, or any other desired items. Thus, the term ‘vehicle’ includes, but is not limited to, automobiles, motorcycles, trucks, airplanes, helicopters, trains, ships and boats, bicycles, and the like. Any ‘vehicle’ may be adapted for use with various embodiments of the present system.

From the foregoing discussion, it will be appreciated by those with ordinary skill in the art that the system of the present invention provides a number of advantages over the prior art, including substantially automatically positioning the mirrors, rather than relying on the operator to remember to do so, in response to a condition in which the mirrors might be damaged. In turn, this allows for mounting larger mirrors or extension mirrors as needed and without constant fear of damage.

Although the invention has been disclosed with reference to various particular embodiments, it is understood that equivalents may be employed and substitutions made herein without departing from the scope of the invention as recited in the claims. For example, it will be appreciated that various components of the system may be adapted for use on particular makes and models of vehicles.

Having thus described the preferred embodiment of the invention, what is claimed as new and desired to be protected by Letters Patent includes the following:

1. A system comprising:
a mirror mounted on a vehicle, the mirror being movable between an open position and a closed position;
a motor operable to, in response to an actuation signal, move the mirror to one of the open and closed positions; and
an onboard controller operable to substantially automatically provide the actuation signal to the motor in response to the occurrence of an actuation condition,
wherein the actuation condition is associated with engaging or disengaging a transmission of said vehicle.

2. The system according to claim 1, wherein the actuation condition is placing said vehicle in park, and further wherein said motor operates to close said mirror in response to said actuation signal.

3. The system according to claim 1, wherein the actuation condition is placing said vehicle in drive, and further wherein said motor operates to open said mirror in response to said actuation signal.

4. A system comprising:
a mirror mounted on a vehicle, the mirror being movable between an open position and a closed position;
a motor operable to, in response to an actuation signal, move the mirror to one of the open and closed positions; and
an onboard controller operable to substantially automatically provide the actuation signal to the motor in response to the occurrence of an actuation condition,
wherein the actuation condition is associated with the initiation of a shift from a first gear of said vehicle to a second gear of said vehicle.

5. A vehicle-mounted system for activation of a remote event, the system comprising:
a transmitter adapted to transmit an activation signal to a remote receiver for activation of a remote event, said activation signal being transmitted in response to an actuation signal; and
an onboard controller operable to substantially automatically provide said actuation signal to said transmitter when the vehicle enters a predetermined location as determined by global positioning system technology.

6. The vehicle-mounted system of claim 5 wherein said remote event is the control of a garage door, and said onboard controller provides said actuation signal to said transmitter when the vehicle enters a predetermined location with respect to said garage door as determined by global positioning system technology.

7. The vehicle-mounted system of claim 5 wherein said remote event is the control of a gate, and said onboard controller provides said actuation signal to said transmitter when the vehicle enters a predetermined location with respect to said gate as determined by global positioning system technology.

8. The vehicle-mounted system of claim 5 wherein said remote event is the control of a hangar door, and said onboard controller provides said actuation signal to said transmitter when the vehicle enters a predetermined location with respect to said hangar door as determined by global positioning system technology.

9. The vehicle-mounted system of claim 5 wherein said remote event is the control of at least one light, and said onboard controller provides said actuation signal to said transmitter when the vehicle enters a predetermined location with respect to said at least one light as determined by global positioning system technology.

10. The vehicle-mounted system of claim 5 wherein said remote event is the control of a security system, and said onboard controller provides said actuation signal to said transmitter when the vehicle enters a predetermined location with respect to said security system as determined by global positioning system technology.

11. A vehicle-mounted system for activation of a remote event, the system comprising:
an onboard controller operable to substantially automatically provide a signal to a remote receiver when the vehicle enters a predetermined location as determined by global positioning system technology, a remote event being initiated by receipt of said signal.

12. The system according to claim 11 wherein said remote receiver is a component of a cell phone system and said remote event is transmission of a text message providing a geographic location of said vehicle.

13. The system according to claim 11 wherein said remote receiver is a component of a cell phone system and said remote event is transmission of a text message providing a message predetermined by an operator of said vehicle.

14. The system according to claim 11 wherein said remote receiver is a Global Positioning Satellite and said remote event is a first remote event, said first remote event being the transmission of a signal by said Global Positioning Satellite, the signal transmitted by said Global Positioning Satellite initiating a second remote event.

15. The vehicle-mounted system of claim 14 wherein said second remote event is the control of a garage door.

16. The vehicle-mounted system of claim 14 wherein said second remote event is the control of a hangar door.

17. The vehicle-mounted system of claim 14 wherein said second remote event is the control of at least one light.

18. The vehicle-mounted system of claim 14 wherein said second remote event is the control of a security system.

19. The vehicle-mounted system of claim 14 wherein said second remote event is the control of a lock.
